(19) United States
(12) Patent Application Publication
(10) Pub. No.: US 2010/0194734 A1
(43) Pub. Date: Aug. 5, 2010

(54) INTEGRATED CIRCUIT DEVICE, ELECTRO OPTICAL DEVICE AND ELECTRONIC APPARATUS

(75) Inventor: Akira MORITA, Shimosuwa-machi (JP)

Correspondence Address: OLIFF & BERRIDGE, PLC, P.O. BOX 320850, ALEXANDRIA, VA, 22320-4850, US

(73) Assignee: SEIKO EPSON CORPORATION, TOKYO (JP)

(21) Appl. No.: 12/696,539

(22) Filed: Jan. 29, 2010

(30) Foreign Application Priority Data
Feb. 4, 2009 (JP) 2009-023268

(51) Int. Cl. G06F 3/038

(52) U.S. Cl. 345/211; 345/94

(57) ABSTRACT

An integrated circuit device includes: a data line driving circuit that is provided for each of a plurality of data signal supply lines and supplies a multiplexed data signal to a corresponding data signal supply line among the plurality of data signal supply lines; a pattern output circuit; and an order setting circuit, wherein a plurality of data signals after demultiplexing obtained by demultiplexing the multiplexed data signal by a demultiplexer are supplied to a plurality of pixels in one horizontal scanning period, the pattern output circuit outputs, as an output rotation pattern, at each frame or each set of plural frames, one of first rotation pattern—M-th (M is a natural number of 2 or more) rotation pattern, which are rotation patterns each defining an order of driving first pixel—p-th (p is a natural number of 2 or more) pixel among the plurality of pixels.

The entire disclosure of Japanese Patent Application No. 2009-23268, filed Feb. 4, 2009 is expressly incorporated by reference herein.

### BACKGROUND

1. Technical Field

An aspect of the present invention relates to integrated circuit devices, electro optical devices and electronic apparatuses.

2. Related Art

In recent years, high definition imaging technology such as high vision imaging have become popular, and higher definition and higher multiple grayscale levels are being pursued for display apparatuses such as liquid crystal projectors and the like. As higher definition and higher multiple grayscale are progressed, the higher the multiple grayscale levels, the smaller the grayscale voltage for each grayscale level becomes, which causes a problem in which display irregularity would occur even when a small error occurs in data voltages.

The applicant has developed a multiplex driving type driver in which each data line driving circuit writes data voltages for a plurality of pixels in each one horizontal scanning period. However, the driver of this type entails a problem in which offsets are generated in the multiple data voltages to be multiplex driven. Due to errors caused by these offsets, there is a problem in that display irregularity (streaks) is generated in the displayed image.

For example, JP-A-2004-45967 (Patent Document 1) describes a method for averaging errors in data voltages by switching the order of driving a plurality of data lines to be multiplex-driven in each of the horizontal scanning periods.

### SUMMARY

In accordance with some embodiments of the invention, integrated circuit devices, electro optical devices and electronic apparatuses that can prevent display irregularity can be provided.

An embodiment of the invention pertains to an integrated circuit device having; a data line driving circuit that is provided for each of a plurality of data signal supply lines and supplies a multiplexed (time-division multiplexed) data signal to a corresponding data signal supply line among the plurality of data signal supply lines; a pattern output circuit; and an order setting circuit, wherein a plurality of data signals after demultiplexing obtained by demultiplexing the multiplexed data signal by a demultiplexer are supplied to a plurality of pixels in one horizontal scanning period, the pattern output circuit outputs, as an output rotation pattern, at each frame or each set of plural frames, one of first rotation pattern—M-th (M is a natural number of 2 or more) rotation pattern, which are rotation patterns each defining the order of driving first pixel—p-th (p is a natural number of 2 or more) pixel among the plurality of pixels, and the order setting circuit sets an order of driving the first pixel—the p-th pixel based on the output rotation pattern.

In accordance with an aspect of the embodiment of the invention, the pattern output circuit outputs, at each frame or in each set of plural frames, one of the first rotation pattern—the M-th rotation pattern, as an output rotation pattern, and the order setting circuit sets an order of driving the first—p-th pixels based on the output rotation pattern, and each of the data line driving circuits performs a multiplex driving of writing data signals to the first—p-th pixels in one horizontal scanning period according to the driving order.

In this manner, in accordance with one aspect of the present embodiment of the invention, the order setting circuit sets an order of driving the first—p-th pixels based on an output rotation pattern, whereby the order of driving the first—p-th pixels can be rotated. By this, order offsets that are offsets generated in data signals (data voltages or data currents) depending on the order of driving pixels are averaged, whereby display irregularities can be prevented.

If there is only one rotation pattern, the more the number of pixels to be multiplex-driven, the more the frequency of averaging operations by rotation becomes, which would more likely generate display irregularities.

In this respect, in accordance with an aspect of the embodiment of the invention, the pattern output circuit outputs one of the first—M-th rotation patterns at each frame or each set of plural frames as an output rotation pattern. By this, the plural rotation patterns can be switched in each frame or each set of plural frames, whereby the frequency of averaging operations by rotation can be made higher. Therefore, even when the number of pixels to be multiplex-driven increases, display irregularities can be prevented.

In one aspect, the embodiment of the invention may include a switch signal generation circuit that generates a demultiplexing switch signal for controlling on and off of a plurality of demultiplexing switch elements included in the demultiplexer.

By so doing, switching on and off of the plurality of demultiplexing switch elements included in the demultiplexer can be controlled. By this, multiplexed data signals can be demultiplexed by the demultiplexer.

For example, the demultiplexer may be included in an electro optical panel, and the demultiplexing switch signal may be supplied to the demultiplexer within the electro optical panel, whereby demultiplexing of the data signal may be realized. Alternatively, the demultiplexer may be included in an integrated circuit device in accordance with the present invention, and the demultiplexing switch signal may be supplied to the demultiplexer within the integrated circuit device, whereby demultiplexing of the data signal may be realized.

Also, in one aspect, the embodiment of the invention may include an output selection circuit that is provided corresponding to the data line driving circuit and selects and outputs, based on a pixel selection signal from the order setting circuit, one of first image data—p-th image data corresponding to the first pixel—the p-th pixel.

For example, in accordance with an aspect of the embodiment of the invention, the output selection circuit may, upon receiving a pixel selection signal instructing to select the q-th pixel (q is a natural number less than p) among the first—p-th pixels, select the q-th image data from among the first—p-th image data, and output the selected q-th image data as selected image data,

By so doing, each of the data line driving circuits can perform multiplex driving by which data signals are written to the first—p-th pixels in each horizontal scanning period according to the driving order given from the order setting circuit.

In accordance with an aspect of the present embodiment of the invention, the pattern output circuit may include a first pattern register—a M-th pattern register that store the first rotation pattern—the M-th rotation pattern, and a pattern selection circuit that selects and outputs one of the first rotation pattern—the M-th rotation pattern stored in the first pattern register—the M-th pattern register at each frame or each set of plural frames.

In this manner, the pattern output circuit includes the first—M-th pattern registers, whereby the first—M-th rotation patterns can be stored. Furthermore, as the pattern selection circuit selects and outputs one of the first M-th rotation patterns stored, one of the first—M-th rotation patterns can be outputted as an output rotation pattern at each frame or each set of plural frames.

Also, in accordance with an aspect of the embodiment of the invention, in a double speed drive in which the frame frequency is 120 Hz, M may be set to 3, and the first rotation pattern—the M-th rotation pattern may be rotated at 40 Hz and outputted as the output rotation patterns.

Furthermore, in accordance with an aspect of the embodiment of the invention, in a triple speed drive in which the frame frequency is 180 Hz, M may be set to 5, and the first rotation pattern—the M-th rotation pattern may be rotated at 36 Hz and outputted as the output rotation patterns.

In accordance with the aspects of the embodiment of the invention described above, in a double speed drive with M being set to 3, the first-third rotation patterns are rotated at 40 Hz. Moreover, in a triple speed drive with M being set to 5, the first-fifth rotation patterns are rotated at 36 Hz. Accordingly, the averaging operations by rotation can be performed at frequencies which are hard to be visually recognized.

Also, in accordance with an aspect of the embodiment of the invention, the order setting circuit may perform a process to convert the output rotation pattern to a different rotation pattern in each horizontal scanning period or each set of plural horizontal scanning periods, thereby setting the order of driving the first pixel—the p-th pixel.

In this manner, the output rotation pattern is processed to be converted to a different rotation pattern in each horizontal scanning period or each set of plural horizontal scanning periods, whereby order offsets can be averaged within a frame.

Also, in accordance with an aspect of the embodiment of the invention, the order setting circuit may perform a process to convert the output rotation pattern to a different rotation pattern in each frame or each set of plural frames, thereby setting the order of driving the first pixel—the p-th pixel.

In this manner, the output rotation pattern is processed to be converted to a different rotation pattern in each frame or each set of plural frames, whereby order offsets can be averaged within a plurality of frames.

Also, in accordance with an aspect of the present embodiment of the invention, the order setting circuit may include a conversion signal generation circuit that outputs a conversion signal that changes in each horizontal scanning period or each set of plural horizontal scanning periods and in each frame or each set of plural frames, and a rotation conversion circuit that processes to convert the output rotation pattern to a different rotation pattern based on the conversion signal.

By so doing, it is possible to realize a process to convert the output rotation pattern to a different rotation pattern in each horizontal scanning period or each set of plural horizontal scanning periods. Also, it is possible to realize a process to convert an output rotation pattern QPT to a different rotation pattern in each vertical scanning period or each set of plural vertical scanning periods.

Also, in accordance with an aspect of the embodiment of the invention, the conversion signal generation circuit may include a vertical synchronization counter that counts the number of frames, a horizontal synchronization counter that counts the number of horizontal scanning periods, a selection timing generation circuit that generates a pixel selection timing signal in the demultiplexing, and an addition circuit that processes addition of an output value of the vertical synchronization counter, an output value of the horizontal synchronization counter and an output value of the selection timing generation circuit.

In accordance with an aspect of the embodiment, as the vertical synchronization counter counts the number of frames, the output value of the vertical synchronization counter changes at each frame or each set of plural frames. Also, as the horizontal synchronization counter counts the number of horizontal scanning periods, the output value of the horizontal synchronization counter changes at each horizontal scanning period or each set of plural horizontal scanning periods. Further, as the addition circuit processes addition of the output values of these counters, it is possible to output a conversion signal that changes at each horizontal scanning period or each set of plural horizontal scanning periods, and changes at each frame or each set of plural frames.

In accordance with an aspect of the embodiment of the invention, the selection timing generation circuit may generate count values that rotate at each count value as the pixel selection timing signals.

In this manner, the selection timing generation circuit can generate pixel selection timing signals. By this, the order setting circuit can sequentially output pixel selection signals according to the pixel selection timing signals.

In accordance with an aspect of the embodiment of the invention, each rotation pattern in the first rotation pattern—the M-th rotation pattern may be composed of first pixel selection data—p-th pixel selection data, the conversion signal generation circuit may output a pixel selection data instruction signal as the conversion signal, and the rotation conversion circuit may output pixel selection data from among the first pixel selection data—the p-th pixel selection data of the output rotation pattern, which is instructed by the pixel selection data instruction signal, as a pixel selection signal, thereby setting the order of driving the first pixel—the p-th pixel.

By so doing, based on a conversion signal, relevant pixel selection data among the first—p-th pixel selection data of the output rotation pattern can be outputted as a pixel selection signal. By this, the process of converting the output rotation pattern to a different rotation pattern can be realized.

Also, in one aspect, the present embodiment of the invention may include an order offset register that stores a first order offset setting value—a p-th order offset setting value corresponding to order offsets that are offsets generated in the plurality of data signals after the demultiplexing depending on the order of driving the first pixel—the p-th pixel, and an order offset addition circuit corresponding to each of the data line driving circuits, wherein, when each of the data line driving circuits drives, among the first pixel—the p-th pixel, the q-th (q is a natural number less than p) pixel in the r-th (r is a natural number less than p) place in the order, the order offset addition circuit may process addition of an order offset correction value based on the r-th order offset setting value among the first order offset setting value—the p-th order offset setting value to the q-th image data among the first image data—the p-th image data corresponding to the first pixel—the p-th pixel.

In accordance with an aspect of the embodiment of the invention described above, the order offset register stores the first—p-th order offset setting values correlated to the first—p-th places in the driving order. By so doing, an order offset correction value corresponding to the r-th place in the driving order can be obtained based on the r-th order offset setting value.

According to an aspect of the embodiment of the invention, when the data line driving circuit drives the q-th pixel in the r-th place in the driving order, the order offset addition circuit processes addition of an order offset correction value corresponding to the r-th place in the driving order to the q-th image data. By this, for the q-th pixel to be driven in the r-th place in the driving order, the order offset corresponding to the r-th place in the driving order can be corrected. In this manner, display irregularities due to order offsets in data signals can be prevented.

In this manner, in accordance with an aspect of the embodiment of the invention, by correcting order offsets, the order offsets can be suppressed. This can make averaging of order offsets by rotation more effective.

Furthermore, another embodiment of the invention pertains to an electro optical device including any one of the integrated circuit devices described above.

Also, still another embodiment of the invention pertains to an electronic apparatus including the electro optical device described above.

### BRIEF DESCRIPTION OF THE DRAWINGS

FIG. 1 is a diagram of an example of the composition of an electro optical device.

FIG. 2 is a diagram of an example of the composition of a data driver.

FIG. 3 is a chart for describing operations of a multiplex drive.

FIG. 4 is a chart for describing operations of a multiplex drive.

FIG. 5 is a diagram for describing order offsets.

FIG. 6 is a chart for describing order offsets.

FIG. 7 is a diagram of a first exemplary composition in accordance with an embodiment of the invention.

FIG. 8 is a detailed exemplary composition of a pattern output circuit and an order setting circuit.

FIG. 9 is a table for describing operations of the first exemplary composition.

FIGS. 10A and 10B are tables for describing operations of the first exemplary composition.

FIG. 11 is a table for describing a comparison example with respect to the embodiment of the invention.

FIG. 12 is a diagram of a second exemplary composition of the embodiment of the invention.

FIG. 13 is a table for describing operations of the second exemplary composition.

FIG. 14 is a modified example of the data driver.

FIG. 15 is a diagram of an exemplary composition of an electronic apparatus.

### DESCRIPTION OF EXEMPLARY EMBODIMENTS

Preferred embodiments of the invention are described in detail below. It is noted that the embodiments described below do not unduly limit the content of the invention recited in the scope of the claimed invention, and all of the compositions to be described in the embodiments may not necessarily be indispensable as means for solution provided by the invention.

### 1. Multiplex Drive

### 1.1. Exemplary Composition of Liquid Crystal Display Device

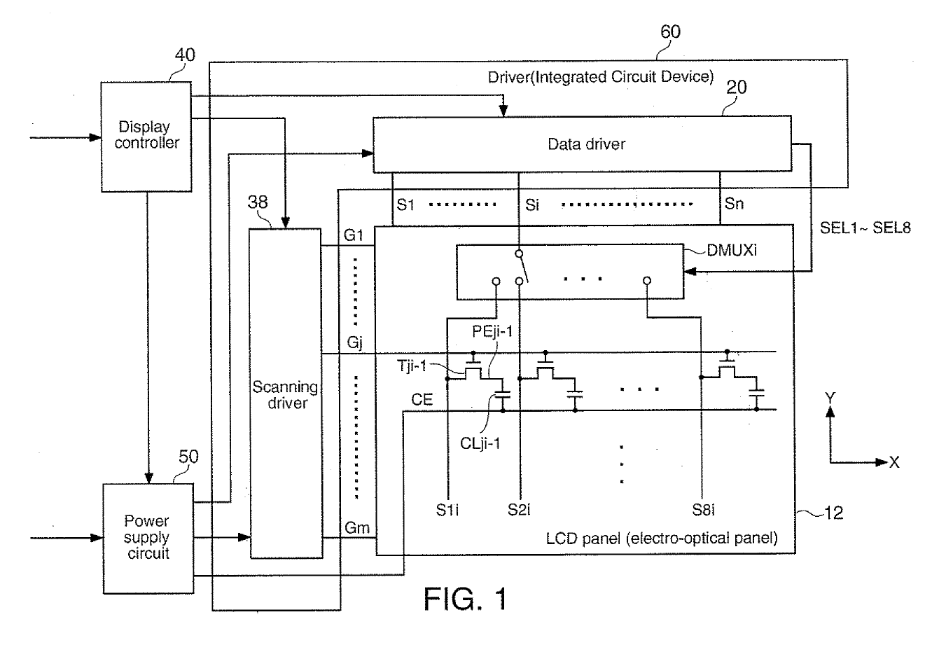

Referring to FIGS. 1-4, multiplex drive (line sequential drive) to be performed by the present embodiment will be described.

An example in which a single color display liquid crystal panel that may be used for a liquid crystal projector and the like is driven by a driver (an integrated circuit device) will be described below. However, in accordance with an embodiment of the invention, a liquid crystal panel that displays multiple colors such as RGB may be driven by a driver. Also, in accordance with an embodiment of the invention, an electro optical panel other than a liquid crystal panel may be driven by a driver. For example, an EL (electro-luminescence) panel, such as, for example, an organic EL panel, an inorganic EL panel or the like may be driven by a driver.

Also, an embodiment in which data voltages are supplied as data signals to data signal supply lines to be described below will be described as an example. However, in accordance with another embodiment of the invention, data currents may be supplied as data signals to the data signal supply lines.

FIG. 1 shows an exemplary composition of a liquid crystal display device (LCD or an electro optical device in a broader sense). The exemplary composition shown in FIG. 1 includes a liquid crystal panel 12 (an electro optical panel in a broader sense), a driver 60 (an integrated circuit device), a display controller 40, and a power supply circuit 50. It is noted that the liquid crystal display device in accordance with the invention is not limited to the composition shown in FIG. 1, and many modifications including omission of a portion of the components (for example, the display controller or the like), addition of other components and the like are possible. For example, FIG. 1 shows an example in which a demultiplexer to be described below is included in a liquid crystal panel. However, in accordance with another embodiment of the invention, the demultiplexer may be included in a data driver 20 to be described below.

The liquid crystal panel 12 may be comprised of, for example, an active matrix type liquid crystal panel. The liquid crystal panel 12 has a liquid crystal substrate (for example, a glass substrate), on which scanning lines G1-Gm (m is a natural number of 2 or greater) arranged in plurality in Y direction of FIG. 1, and extending in X direction are disposed. Also, data lines S11-S81, S12-S82, . . . , S1n-S8n (n is a natural number of 2 or greater) arranged in plurality in X direction, and extending in Y direction are disposed on the liquid crystal substrate. Furthermore, on the liquid crystal substrate are provided data signal supply lines S1-Sn (data voltage supply lines or data current supply lines) and demultiplexers DMUX1-DMUXn corresponding to the data signal supply lines, respectively.

Also, on the liquid crystal substrate, thin film transistors are provided at positions corresponding to intersections between the scanning lines G1-Gm (gate lines) and data lines S11-S81, S12-S82, . . . , S1n-S8n (source lines). For example, a thin film transistor Tji−1 is provided at the position corresponding to an intersection between the scanning line Gj (j is a natural number less than m) and the data line S1i (i is a natural number less than n).

Then, for example, the thin film transistor Tji−1 has a gate electrode that is connected to the scanning line Gj, a source electrode connected to the data line S1i, and a drain electrode connected to a pixel electrode PEji−1.A liquid crystal capacitance CLji−1 (a liquid crystal element, an electro optical element in a broader sense) is formed between the pixel electrode PEji-1 and a counter electrode CD (common electrode).

The demultiplexers DMUX1-DMUXn divide (separate, demultiplex) time-division data voltage (or data current, data signal in a broader sense) supplied to the data signal supply line (source voltage supply line) and supply the same to the data lines. More concretely, the demultiplexer DMUXi includes switch elements (a plurality of demultiplex switch elements) corresponding to the respective data lines. The switch elements are controlled to turn on and off by demultiplex switch signals SEL1-SEL8 (multiplex control signals) from the data driver 20, whereby the data voltage (source voltage) supplied to the data signal supply line Si is divided and supplied to the data lines S1i-S8i.

It is noted that FIG. 1 shows only the demultiplexer DMUXi and the data lines S1i-S8i corresponding to the data signal supply line Si, for the sake of simplification of the description. Also, only the thin film transistors provided at the positions corresponding to intersections between the data lines S1i-S8i and the scanning line Gj are shown. However, demultiplexers and data lines for other data signal supply lines and thin film transistors provided at positions corresponding to intersections of other data lines and scanning lines are similarly provided.

The data driver 20 outputs time-division data voltage to the data signal supply lines S1-Sn based on image data (grayscale data), thereby driving the data signal supply lines S1-Sn. On the other hand, the scanning driver 38 scans (sequentially drives) the scanning lines G1-Gm of the liquid crystal panel 12.

The display controller 40 controls the data driver 20, the scanning driver 38 and the power supply circuit 50. For example, the display controller 40 sets operation modes, supplies vertical synchronization signals and horizontal synchronization signals generated therein to the data driver 20 and the scanning driver 38. The display controller 40 performs controlling of the above according to contents set by, for example, an unshown host controller (for example, a central processing unit (CPU))

The power supply circuit 50 generates various voltage levels (for example, reference voltages for generating grayscale voltages) necessary for driving the liquid crystal panel 12, voltage levels of counter electrode voltages VCOM on the counter electrode CE, based on the reference voltage (power supply voltage) supplied from outside.

Referring to FIG. 1, an example in which the data voltages are supplied to eight data lines from one data signal supply line in the single color display liquid crystal panel is described. However, in accordance with the invention, the data voltage may be supplied to a different number of data lines from one data signal supply line. For example, in accordance with an aspect of the invention, in the case of an RGB display liquid crystal panel, data voltage may be supplied from one data signal supply line to six data lines corresponding to R1, G1, B1, R2, G2 and B3.

### 1.2. Data Driver

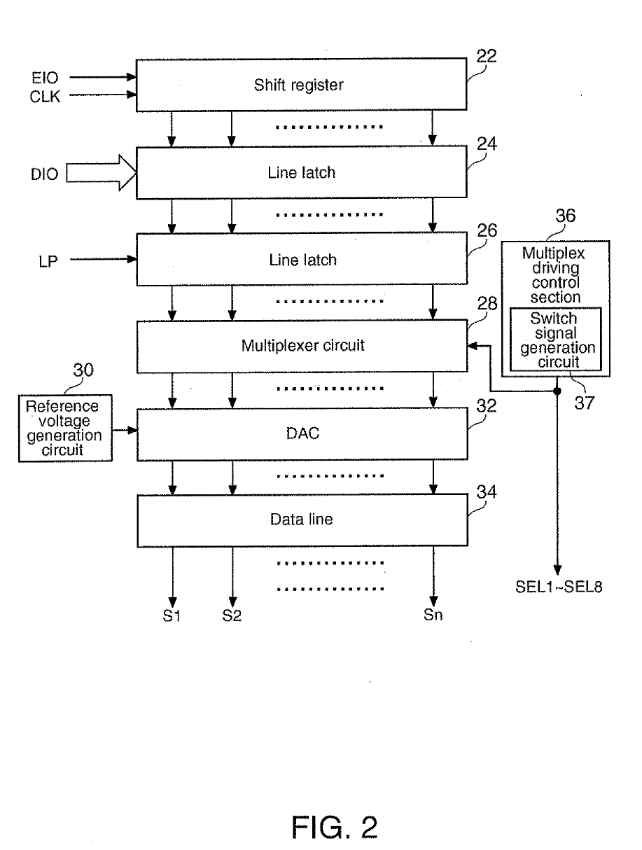

FIG. 2 shows an exemplary composition of the data driver 20 shown in FIG. 1. The data driver 20 includes a shift register 22, line latches 24, 26, a multiplexer circuit 28, a reference voltage generation circuit 30 (a grayscale voltage generation circuit), a DAC 32 (digital-to-analog converter, a data voltage generation circuit in a broader sense), a data line driving circuit 34 and a multiplex drive control section 36.

The shift register 22 is provided for each of the data lines, and includes a plurality of sequentially connected flip-flops. The shift register 22 operates in synchronism with a clock signal CLK, and upon retaining an enable I/O signal EIO at the leading flip-flop, sequentially shifts the enable I/O signal EIO to an adjacent one of the flip-flops.

Image data DIO (grayscale data) is inputted in the line latch 24. The line latch 24 latches the image data DIO in synchronism with the enable I/O signal EIO that is sequentially shifted, inputted from the shift register 22.

The line latch 26 latches image data latched by the line latch 24 for the unit of one horizontal scanning, in synchronism with horizontal synchronization signals LP.

It is noted that the clock signal CLK, the enable I/O signal EIO, the image data DIO and horizontal synchronization signals LP are inputted from, for example, the display controller 40.

The multiplexer circuit 28, upon receiving image data corresponding to each data line from the line latch 26, time-division multiplexes the image data corresponding to eight data lines, and outputs the time-division multiplexed image data corresponding to each of the data signal supply lines. The multiplexer circuit 28 multiplexes image data based on multiplex control signals SEL1-SEL8 from the multiplex drive control section 36.

The multiplex drive control section 36 generates multiplex control signals SEL 1-SEL 8 that specify the timing of time-division of data voltages. More specifically, the multiplex drive control section 36 includes a switch signal generation circuit 37, and the switch signal generation circuit 37 generates multiplex control signals SEL1-SEL8. Then, the multiplex drive control section 36 supplies the multiplex control signals SEL1-SEL8 as demultiplex switch signals to the demultiplexers DMUX1-DMUXn.

The reference voltage generation circuit 30 generates a plurality of reference voltages (grayscale voltages), and supplies the same to the DAC 32. The reference voltage generation circuit 30 generates a plurality of reference voltages based on, for example, a voltage level supplied from the power supply circuit 50.

The DAC 32 generates analog grayscale voltages to be supplied to each of the data lines based on digital image data. More specifically, the DAC 32 receives the time-division multiplexed image data from the multiplexer circuit 28 and the plurality of reference voltages from the reference voltage generation circuit 30, and generates time-division multiplexed grayscale voltages corresponding to the time-division multiplexed image data.

The data line driving circuit 34 buffers (impedance-converts) the grayscale voltages from the DAC 32 and outputs data voltages to the data signal supply lines S1-Sn, thereby driving the data lines S11-S81, S12-S82, . . . , S1n-S8n. For example, the data line driving circuit 34 buffers the grayscale voltages with a voltage-follower connected operation amplifier provided at each of the data signal supply lines.

### 1.3. Operations of Multiplex Driving

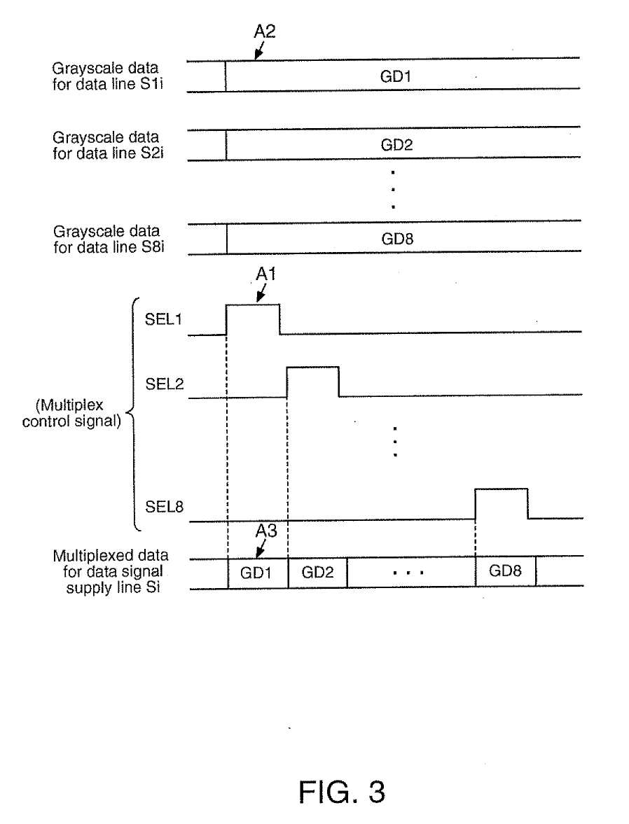

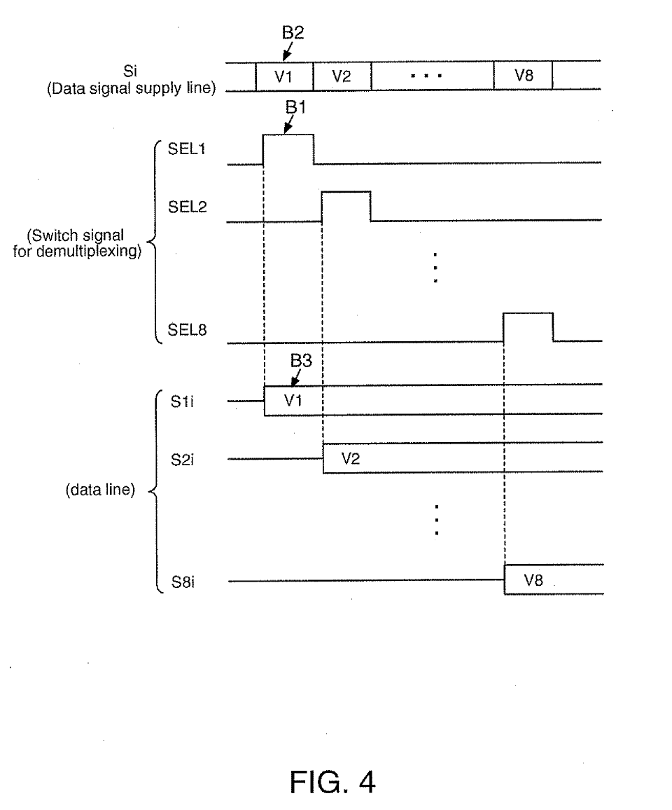

FIGS. 3 and 4 show charts for describing operations of the multiplex driving circuit 36. It is noted that, referring to FIGS, 3 and 4, an example of operations of the demultiplexer DMUXi is described, However, the description thereof is similarly applicable to the other demultiplexers.

FIG. 3 shows a chart for explaining operations of the multiplexer circuit 28. As shown in FIG. 3, as the image data for the data lines S1i-S8i, image data GD1-GD8 are latched by the line latch 26.

When the multiplex control signal SEL1 becomes active as indicated by A1 in FIG. 3, the multiplexer circuit 28 selects the image data GD1 indicated at A2, as indicated by A3 and outputs the same. Then, when the multiplex control signal SEL2 becomes active, the multiplexer circuit 28 selects and outputs the image data GD2. When the multiplex control signal SEL8 becomes active, the multiplexer circuit 28 selects and outputs the image data GD8.

In this manner, the multiplexer circuit 28 generates multiplex data of the image data GD1-GD8 that are time-division multiplexed, based on the multiplex control signals SEL1-SEL8, each of which becomes active once in each one horizontal scanning period.

Upon receiving the time-division multiplexed image data GD1-GD8, the DAC 32 selects a grayscale voltage corresponding to each of the image data from among the reference voltages (grayscale voltages) and outputs the same. Then, the DAC 32 outputs the time-division multiplexed image data.

FIG. 4 is a chart for describing operations of the demultiplexer DMUXi. As shown in FIG. 4, upon receiving the multiplexed grayscale voltage from the DAC, the data line driving circuit 34 outputs multiplexed data voltages V1-V8 in one horizontal scanning period.

Then, the demultiplexer DMUXi outputs the data voltage V1 indicated by B2 to the data line S1i as indicated by 133, when the multiplex control signal SEL1 is active as indicated by B1 in FIG. 4. Similarly, the demultiplexer DMUXi outputs the data voltage V2 to the data line S2i when the multiplex control signal SEL2 is active, and outputs the data voltage V8 to the data line S8i when the multiplex control signal SEL8 is active.

In this manner, the demultiplexer DMUXi separates the multiplexed data voltages V1-V8 supplied to the data signal supply line Si, and outputs the same to the data lines S1i-S8i.

### 2. Rotation

### 2.1. Order Offset

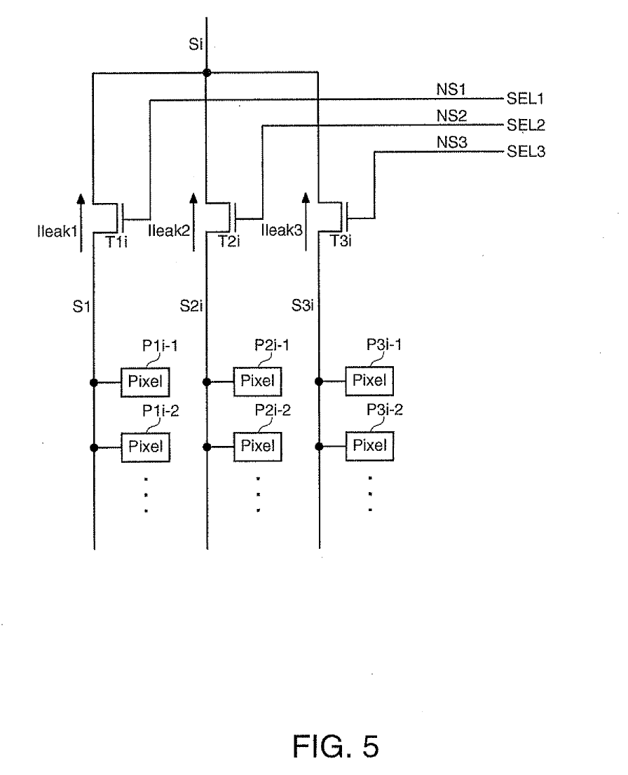

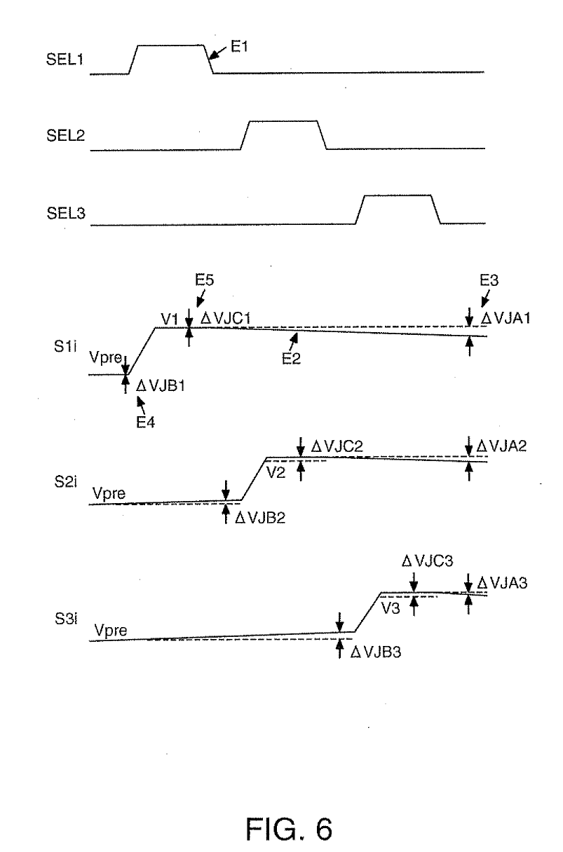

Referring to FIGS. 5 and 6, order offsets in the multiplex drive will be described. FIG. 5 schematically shows an exemplary arrangement composition of a liquid crystal panel (an electro optical panel). FIG. 5 shows an example in which multiplex driving is conducted for each three pixels, wherein the arrangement composition of the data lines S1i-S3i and the data signal supply line Si is shown as an example.

As shown in FIG. 5, data lines S1i-S3i are arranged on the liquid crystal panel. Plural pixels to be multiplex-driven are provided on the data lines S1i-S3i. For example, pixels P1i−1, P1i−2 are provided on the data line S1i, pixels P2i−1, P2i−2 are provided on the data line S2i, and pixels P3i−1, P3i−2 are provided on the data line S3i. In multiplex driving, for example, pixels P1i−1, P2i−1, P3i−1 are driven in a time-division manner in one horizontal scanning period.

Also, a data signal supply lines Si is arranged on the liquid crystal panel. Further, between the data signal supply line Si and the data lines S1i-S3i, transistors T1i-T3i (for example, N-type transistors) are provided, respectively, as the switch elements (demultiplexing switch elements) of the demultiplexer DMUXi. The multiplex control signals SEL1-SEL3 are inputted through signal lines NS1-NS3 to the gates of the transistors T1i-T3i, respectively.

When the transistors T1i-T3i turn off after the transistors T1i-T3i have been turned on and the data lines S1i-S3i have been driven, leak current I leak1-I leak3 flow between the data lines S1i-S3i and the data signal supply line Si through the transistors T1i-T3i. For example, the leak currents I leak1-I leak3 are generated when the transistors T1i-T3i are illuminated with backlight.

Then, as indicated by E1 in FIG. 6, when the multiplex control signal SEL1 becomes non-active and the transistor T1i turns off, the voltage on the data line S1i changes due to the leak current I leak1, as indicated by E2. Then, as indicated by E3, the data voltage on the data line S1i finally becomes to be V1+ΔVJA1, which includes a voltage change amount ΔVJA1. Similarly, the data voltages on the data lines S2i, S3i finally become V2+ΔVJA2, V3+ΔVJA3, respectively.

In this instance, the amount of voltage change, ΔVJA1, ΔVJA2 and ΔVJA3, is affected by the time duration in which each of the leak currents I leak1-I leak3 flows, in other words, the longer time the leak current flows, the greater the amount of voltage changes. For this reason, the amount of voltage change, ΔVJA1-ΔVJA3, differ depending on the order of driving pixels (drive timing).

In this manner, in multiplex driving, there is a problem in that order offsets ΔVJA1-ΔVJA3 (errors, deviations, variations) that differ depending on the order of pixel driving occur in data voltages to be written to pixels on the data lines S1i-S3i.

Also, the leak currents I leak1-I leak3 are affected by the data voltage to be written to pixels and the voltage on the data signal supply lines Si, whereby their magnitude change. Therefore, there is also a problem in that the order offsets ΔVJA1-ΔVJA3 would become to be offsets having an inclination in its characteristic with respect to the grayscale of image data.

Therefore, in accordance with the present embodiment, in each horizontal scanning period, a pre-charge voltage Vpre may be applied to pixels, and the data voltage may be written to the pixels through multiplex driving. The pre-charge voltage Vpre is a voltage to be applied for initializing the voltage of the pixels, and/or for shortening the time of writing the data voltage.

During the period after application of the pre-charge voltage Vpre until the pixels are driven, the data lines S1i-S3i are set in a high impedance state. For this reason, the pre-charge voltage Vpre is retained by liquid crystal capacitance of the pixels and parasitic capacitance of the data lines S1i-S3i.

In this instance, the liquid crystal capacitance of the pixels change its capacitance value as the orientation of the liquid crystal changes in response to the pre-charge voltage Vpre. Therefore, as the data lines S1i-S3i are in a high impedance state, the voltage on the data lines S1i-S3i change according to changes in the liquid crystal capacitance of the pixels. For example, as indicated by E4 in FIG. 6, the data voltage on the data line S1i changes by a voltage change amount ΔVJB1 during the period until the pixels are driven, and becomes to be Vpre+ΔVJB1. Similarly, the data voltages on the data lines S2i, S3i, become to be Vpre+ΔVJB2, Vpre+ΔVJB3, respectively.

In this manner, if the voltage at the start of driving the pixels differs due to the voltage change amount ΔVJB1-ΔVJB3, the data voltage to be written to the pixels changes in its peak point. For example, as indicated by E5, the data voltage to be written to the pixels on the data line S1i changes by a voltage change amount ΔVJC1 due to the voltage change amount ΔVJB1, becoming to be V1+ΔVJC1. Similarly, the data voltages to be written to the pixels on the data lines S2i, S3i become to be V2+ΔVJC2, V3+ΔVJC3, respectively.

The voltage change amount ΔVJB1-ΔVJB3 is a voltage change amount that differs depending on the duration of the period after application of the pre-charge voltage Vpre until the pixels are driven, and therefore is a voltage change amount that differs depending on the order of driving the pixels. Therefore, the voltage change amount ΔVJC1-ΔVJC3 is also a voltage change amount that differs depending on the order of driving the pixels.

In this manner, in multiplex driving, there is also a problem in that order offsets ΔVJC1-ΔVJC3 that differ depending on the order of driving pixels are generated in data voltages to be written to the pixels on the data lines S1i S3i.

Therefore, the order offsets ΔVJA1-ΔVJA3, ΔVJC1-ΔVJC3 cause errors in the luminance of pixels depending on the order of driving the pixels, which leads to a problem of occurrence of streaks (luminance irregularity, color irregularity) in displayed images.

### 2.2. Exemplary Composition

To solve the problems described above, an integrated circuit device of a first exemplary composition in accordance with the present embodiment includes first—n-th (n is a natural number of 2 or greater) data line driving circuits 100-1−100-n (a plurality of data line driving circuits), first—n-th output selection circuits 110-1−110-n (a plurality of output selection circuits), a pattern output circuit 130 and an order setting circuit 140.

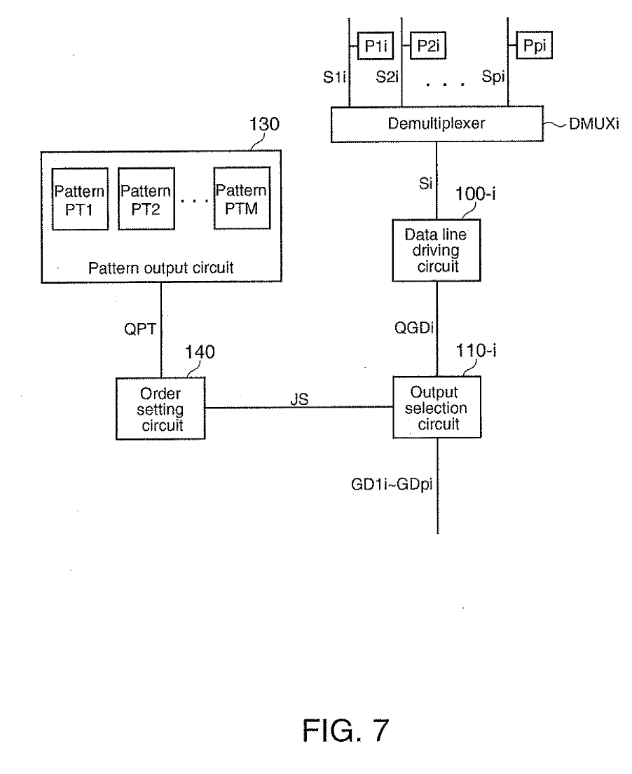

FIG. 7 shows the i-th data line driving circuit 100-i, and the i-th output selection circuit 110-i among the data line driving circuits 100-1−100-n, and the output selection circuits 110-1−110-n of the first exemplary composition.

Hereunder, description will be made with these illustrated components as an example. It is noted that similar description is applicable to the other data line driving circuits, and output selection circuits.

The first exemplary composition pertains to a circuit that averages (disperses) order offsets through setting an order of driving pixels based on a plurality of rotation patterns (dispersion patterns) and performing the multiplex drive (line sequential drive) according to the set driving order.

More specifically, the data line driving circuit 100-i, upon receiving selected image data QGDi from the output selection circuit 110-i, drives a data signal supply line Si (a data voltage supply line, or a data current supply line). More concretely, the data line driving circuit 100-i drives in a time-division manner the data lines S1i-Spi (a plurality of data lines) corresponding to first—p-th pixels P1i-Ppi (a plurality of pixels) in one horizontal scanning period, and writes data voltages (or data currents, or data signals in a broader sense) to the pixels P1i-Ppi.

The output selection circuit 110-i, upon receiving a pixel selection signal JS and image data GD1i-GDpi, outputs selected image data QGDi. More concretely, the output selection circuit 110-i, upon receiving a pixel selection signal JS instructing to select the q-th pixel Pqi (q is a natural number less than p), selects the image data GDqi, and outputs the image data GDqi as the selected image data QGDi.

The order setting circuit 140 sets an order of driving pixels Phi-Ppi based on an output rotation pattern QPT from the pattern output circuit 130. Then the order setting circuit 140 outputs a pixel selection signal JS instructing as to which pixels among the pixels P1i-Ppi should be selected.

The pattern output circuit 130 outputs one of first—M-th (M is a natural number of 2 or greater) rotation patterns PT1-PTM (pattern data) as an output rotation pattern QPT (output pattern data). For example, the pattern output circuit 130 may generate the rotation patterns PT1-PTM with a logic circuit, or may store the rotation patterns PT1-PTM with a register.

The integrated circuit device in accordance with the present embodiment of the invention is not particularly limited to the composition of FIG. 7, and many changes including omission of a portion of the components thereof (for example, the output selection circuit and the like), addition of other components thereto, and the like can be made.

### 2.3. Pattern Output Circuit, Oder Setting Circuit

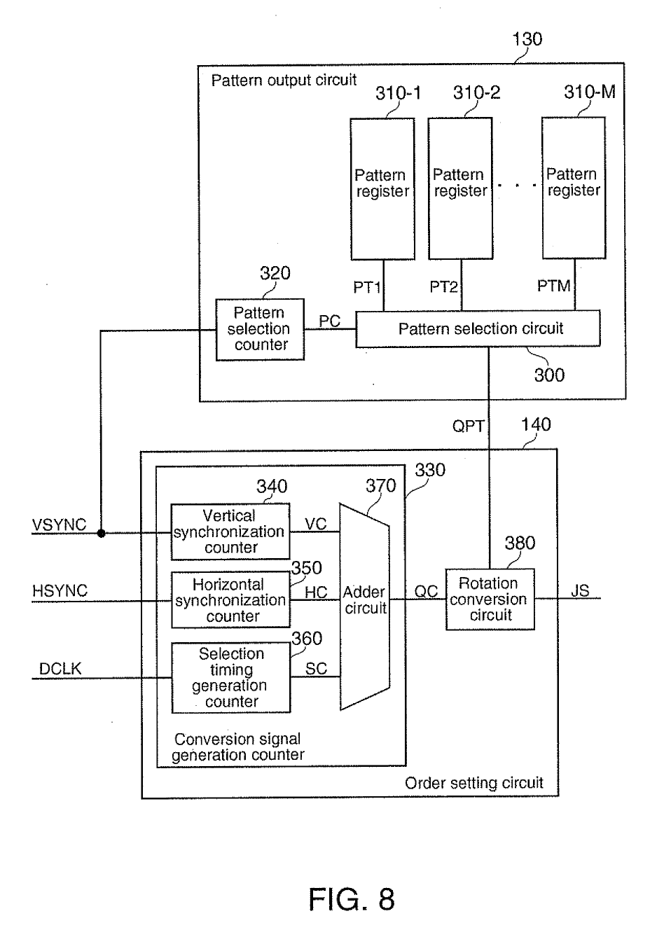

FIG. 8 shows a diagram of a detailed exemplary composition of the pattern output circuit and the order setting circuit. The pattern output circuit 130 shown in FIG. 8 includes a pattern selection circuit 300, first—M-th pattern registers 300-1−300-M, and a pattern selection counter 320.

Pattern registers 310-1−310-M store rotation patterns PTI PTM. For example, the pattern registers 310-1−310-M may be formed from flip-flops, or formed from memories such as random access memories (RAMS), flash memories or the like.

The pattern selection counter 320 outputs a pattern instruction signal PC that instructs as to which rotation patterns among the rotation patterns PT1-PTM should be selected. Concretely, the pattern selection counter 320 counts the number of frames (vertical scanning periods) based on a vertical synchronization signal (VSYNC), and outputs the counted value as a pattern instruction signal PC. For example, pattern selection counter 320 may update (for example, count up or countdown) the count value at each frame, or may update the count value at each set of plural frames.

The pattern selection circuit 300 selects one of the rotation patterns PT1-PTM based on the pattern instruction signal PC from the pattern selection counter 320, and outputs the selected rotation pattern as an output rotation pattern. More concretely, the pattern selection circuit 300, upon receiving a pattern instruction signal PC instructing to select the k-th rotation pattern PTk (k is a natural number less than M), outputs the k-th rotation pattern PTk as an output rotation pattern QPT.

Also, the order setting circuit 140 shown in FIG. 8 includes a conversion signal generation circuit 330 and a rotation conversion circuit 380.

The conversion signal generation circuit 330 outputs a conversion signal QC that changes in each horizontal scanning period or each set of plural horizontal scanning periods and in one frame or a set of plural frames. Also, the conversion signal generation circuit 330 outputs a conversion signal QC that changes at each of the pixel selection timings in multiplex driving. Concretely, the conversion signal generation circuit 330 includes a vertical synchronization counter 340, a horizontal synchronization counter 350 and a selection timing generation circuit 360.

The vertical synchronization counter 340, upon receiving a vertical synchronization signal VSYNC, counts the number of frames, and outputs the counted value as an output value VC. For example, the vertical synchronization counter 340 may update (for example, count up or countdown) the output value VC at each frame, or may update the output value VC at each set of plural frames.

The horizontal synchronization counter 350, upon receiving a horizontal synchronization signal HSYNC, counts the number of horizontal scanning periods, and outputs the counted value as an output value HC. For example, the horizontal synchronization counter 350 may update (for example, count up or countdown) the output value HC at each horizontal scanning period, or may update the output value HC at each set of plural frames.

The selection timing generation circuit 360 generates a pixel selection timing signal for multiplex driving. Concretely, the selection timing generation circuit 360 outputs output values SC that instruct to drive pixels in what places in the driving order, thereby setting the pixel selection timing. For example, the selection timing generation circuit 360 receives a dot clock DCLK, generates count values that rotate in a predetermined count value, and outputs the count value as an output value SC. For example, the selection timing generation circuit 360 may generate count values that rotate in each predetermined count value sequence from 0 to p−1, or may generate count values that rotate at each predetermined count value sequence from p−1 to 0.

The addition circuit 370 processes addition of the output value VC of the vertical synchronization counter 340, the output value HC of the horizontal synchronization counter 350 and the output value SC of the selection timing generation circuit 360, and outputs the added value as a conversion signal QC.

The rotation conversion circuit 380 performs a process to convert the output rotation pattern QPT of the pattern output circuit 130 to a rotation pattern that is different from the output rotation pattern QPT. The rotation conversion circuit 380 performs its conversion process based on a conversion signal QC from the conversion signal generation circuit 330, and outputs the converted data as a pixel selection signal JS.

It is noted here that each of the rotation patterns PT1-PTM is composed of first—p-th pixel selection data (a plurality of pixel selection data). Each of the pixel selection data is data that instructs as to which one of the pixels P1i-Ppi should be selected.

In this instance, the conversion signal generation circuit 330 outputs a pixel selection data instruction signal as a conversion signal QC. The pixel selection data instruction signal is a signal that instructs as to which one of the first—p-th pixel selection data of the output rotation pattern should be outputted.

Then, the rotation conversion circuit 380 selects pixel selection data that is indicated by the pixel selection data instruction signal from among the first—p-th pixel selection data of the output rotation pattern QPT. Then, the rotation conversion circuit 380 outputs the selected pixel selection data as the pixel selection signal JS.

In this manner, the rotation conversion circuit 380 performs the process to convert the output rotation pattern QPT of the pattern output circuit 130.

It is noted that the pattern output circuit and the order setting circuit in accordance with the embodiment of the invention are not limited to the compositions shown in FIG. 8, and many modifications including omission of a portion of the components, addition of other components and the like are possible.

### 2.4. Example of Operations

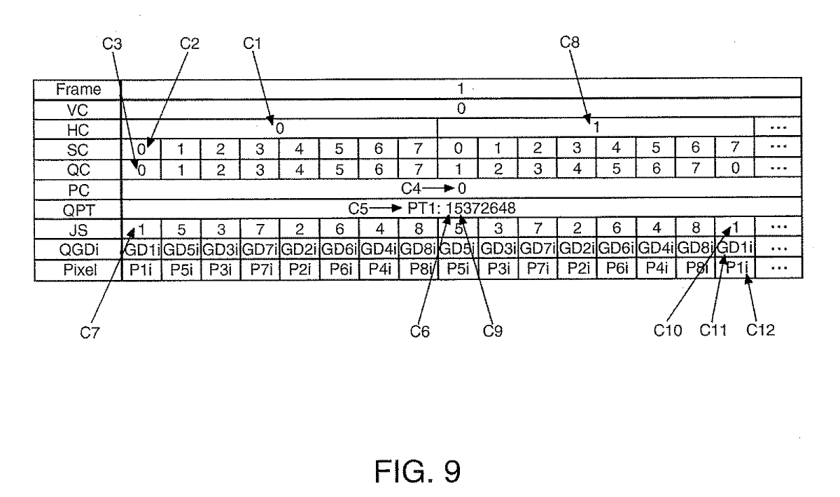

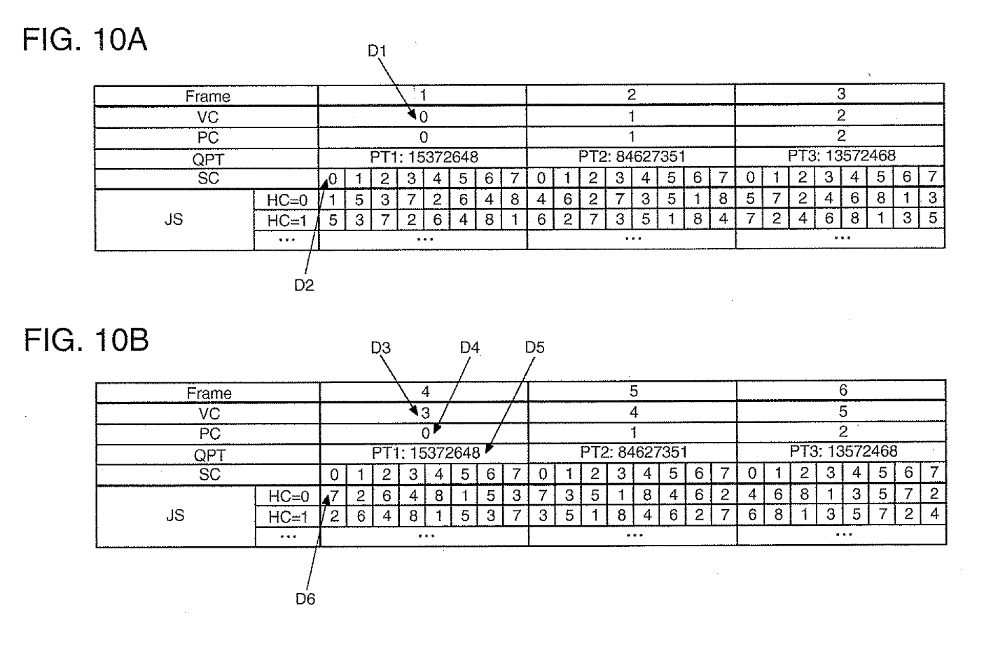

Referring to FIGS. 9, 10A and 10B, an example of operations of the present embodiment will be described. It is noted that, for simplification of the description, the case in which the first—eighth pixels P1i-P8i (p=8) are multiplex-driven will be described as an example with reference to FIGS. 9, 10A and 10B.

FIG. 9 shows an example of operations when the output value VC=0 is outputted in the first frame. As shown in FIG. 9, a count value that is counted up at each horizontal scanning period is outputted as the output value HC. Also, as the output value SC, count values that rotate at each horizontal scanning period with predetermined count values of 0-7 are outputted.

For example, as indicated by C1, an output value HC=0 is outputted in the first horizontal scanning period. In this instance, as indicated by C2, when an output value SC=0 is outputted, the output values VC, HC and SC are added as indicated by C3, and a pixel selection data instruction signal (a conversion signal) QC=VC+HC=SC=0+0+0=0 is outputted.

Here, as indicated by C4, a pattern instruction signal PC=0 is outputted in the first frame. As indicated by C5, an output rotation pattern QPT=PT1 is outputted based on the pattern instruction signal PC=0. The rotation pattern PT1 is composed of first—eighth pixel selection data (1, 5, 3, 7, 2, 6, 4 and 8).

Then, based on the pixel selection data instruction signal QC=0, the first pixel selection data indicated by C6 is selected. The first pixel selection data is outputted as a pixel selection signal JS=1 as indicated by C7. In this manner, as the output values SC=1, 2, . . . are sequentially outputted, the pixel selection data instruction signals QC=0, 1, 2, . . . are outputted, and the pixel selection signals JS=1, 5, 3, . . . are outputted.

In a similar manner, as indicated by C8, an output value HC=1 is outputted in the second horizontal scanning period. In this instance, when an output value SC=0 is outputted, a pixel selection data instruction signal QC=0+1+0=1 is outputted. Then, based on the pixel selection data instruction signal QC=1, a second pixel selection data indicated by C9 is selected, and outputted as a pixel selection signal JS=5. In this manner, as the output values SC=0, 1, 2, . . . , are sequentially outputted, the pixel selection data instruction signals QC=1, 2, 3, are outputted, and the pixel selection signals JS=5, 3, 7, . . . are outputted.

In this manner, by updating the output value HC at each horizontal scanning period, the rotation pattern PT1 is rotated in each eight horizontal scanning periods. Thus, the rotated rotation pattern PT1 is outputted as the pixel selection signal JS. In this manner, the output rotation pattern QPT is processed to convert to a rotation pattern that becomes different at each horizontal scanning period.

For example, as indicated by C10, when a pixel selection signal JS=1 that instructs to select the pixel P1i is outputted, the image data GD1i is selected, and the selected image data QGDi=GD1i is outputted, as indicated by C11. Then, a data voltage corresponding to the selected image data QGDi=GD1i is written to the pixel P1i, as indicated by C12.

In this manner, based on the pixel selection signal JS instructing to select the q-th pixel Pqi, the image data GDqi is selected, and the image data GDqi is outputted as selected image data QGDi.

FIG. 10A and FIG. 10B show examples of operations when VC=0—5. For simplifying the description, the case in which first—third rotation patterns PT1-PT3 (M=3) are outputted will be described with reference to FIGS. 10A and 10B.

As indicated in FIG. 10A, the output value VC is counted up at each frame in the first—third frames, and output values VC=0—2 are outputted. Also, in the first—third frames, the pattern instruction signal PC is counted up at each frame, and pattern instruction signals PC=0—2 are outputted. Then, based on the output values PC=0—2, rotation patterns PT1-PT3 are outputted as output rotation patterns QPT.

In this manner, one of the rotation patterns PT1-PT3 is selected at each of the frames, and the selected rotation pattern is outputted as the output rotation pattern QPT.

Similarly, as shown in FIG. 10B, in the fourth—sixth frames, output values VC=3-5 are outputted, and pattern instruction signals PC=0-2 are outputted. Then, based on the output values PC=0-2, rotation patterns PT1-PT3 are outputted as the output rotation patterns QPT. In this manner, as the pattern instruction signal PC rotates at each three frames, each of the rotation patterns PT1-PT3 is repeatedly outputted at each three frames.

Here, as indicated by D1 in FIG. 10A, an output value VC=0 is outputted in the first frame. As described with reference to FIG. 9, when the output value HC=0, as the output values SC=0, 1, 2, . . . are sequentially outputted, the pixel selection data instruction signals QC=0, 1, 2, . . . are outputted. Then, as indicated by D2, the pixel selection signal JS=1, 5, 3, . . . are outputted.

On the other hand, as indicated by D3 in FIG. 10B, an output value VC=3 is outputted in the fourth frame. Also, as indicated by D4, a pattern instruction signal PC=0 is outputted in the fourth frame, and an output rotation pattern QPT=PT1 is outputted, as indicated by D5. As the output value VC=3, when the output values SC=0, 1, 2, . . . are sequentially outputted with the output value HC=0, pixel selection data instruction signals QC=3, 4, 5, are outputted. Then, as indicated by D6, pixel selection signal JS=7, 2, 6 , are outputted.

In this manner, by updating the output value VC at each frame, the rotation pattern PT1 that is outputted at each three frames is rotated. Then, the rotated rotation pattern PT1 is outputted as the pixel selection signal JS. In this manner, the output rotation pattern QPT=PT1 is processed to convert to different rotation patterns in each three frames (a plurality of frames).

The operation example in which the output rotation pattern QPT is processed to convert to different rotation patterns in each horizontal scanning period is described above with reference to FIGS. 9, 10A and 10B. However, in accordance with the invention, the output rotation pattern QPT may be processed to convert to different rotation patterns in each set of plural horizontal scanning periods. For example, in the example of FIG. 9 described above, by counting up the output value HC in each set of plural horizontal scanning periods, the output rotation pattern QPT may be processed to convert to a different rotation pattern in each set of plural horizontal scanning periods.

Also, with reference to FIG. 9, FIG. 10A and FIG. 10B, the operation example in which the output rotation pattern QPT is processed to convert to different rotation patterns in each three frames (a plurality of frames) is described. However, in accordance with the invention, the output rotation pattern QPT may be processed to convert to a different rotation pattern at each one frame. For example, in the example described above with reference to FIG. 10A, the pattern instruction signal PC may be counted up at each two frames, such that the output rotation pattern QPT=PT1 is outputted in the first and second frames. In this case, the output value VC may be counted up as 1, 0, such that the output rotation pattern QPT=PT1 is processed to convert to a different rotation pattern at each frame.

### 2.5. Averaging of Order Offset by Rotation

It is noted here that, in multiplex driving, there is a problem in that offsets (for example, ΔVJA1-ΔVJA3, ΔVJC1-ΔVJC3 described above with reference to FIG. 6) that differ depending on the order of driving pixels are generated in data voltages for the pixels. Further, there is a problem in that the order offsets cause to generate display irregularities.

In this respect, in accordance with the present embodiment, the pattern output circuit 130 outputs one of the rotation patterns PT1—PTM at each frame or each set of plural frames as the output rotation pattern QPT, the order setting circuit 140 sets an order of driving the pixels P1i—Ppi based on the output rotation pattern QPT, and the data line driving circuit 100-i writes data voltages to the pixels P1i—Ppi in one horizontal scanning period according to the driving order, thereby performing a multiplex drive.

In accordance with the present embodiment, the order setting circuit 140 sets an order of driving the pixels P1i—Ppi based on the output rotation pattern QPT. By this, the driving order for the pixels P1i—Ppi can be rotated (dispersed). Then, by rotating the driving order for the pixels P1i—Ppi, the order offsets can be averaged (averaged spatially, averaged time-wise), whereby display irregularities can be prevented.

Multiplex driving also entails a problem in that the frequency of averaging operations by rotation becomes lower as the number of pixels to be multiplex-driven increases, which would more likely generate display irregularities.

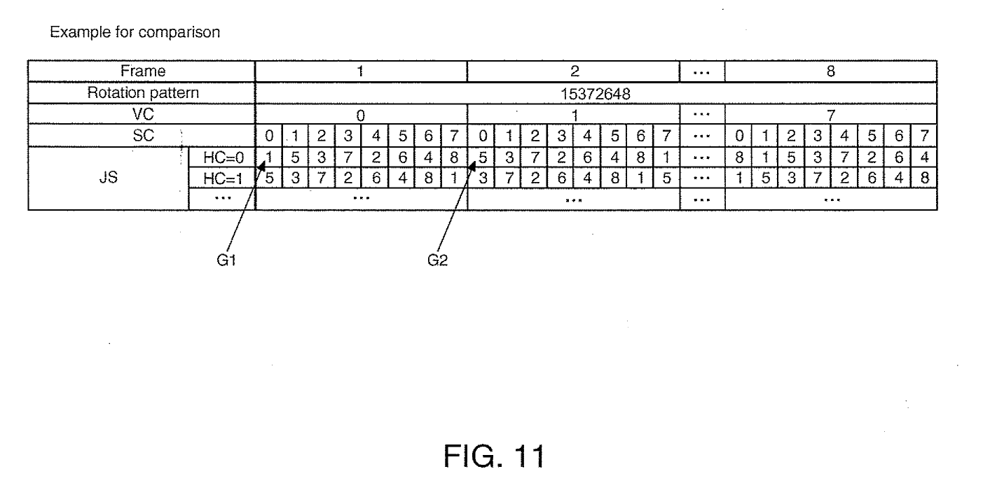

In this respect, the problem will be described more concretely with reference to FIG. 11. FIG. 11 shows, as a comparison example with respect to the present embodiment, an example with only one rotation pattern.

As indicated by G1 in FIG. 11, in the first horizontal scanning period in the first frame, at an output value SC=0, the first pixel selection data is outputted as the pixel selection signal JS. Then, as output values SC=0, 1, 2, . . . are sequentially outputted, pixel selection signals JS=1, 5, 3, . . . are sequentially outputted. Similarly, as indicated by G2, in the first horizontal scanning period in the second frame, pixel selection signals JS=5, 3, 7, . . . are sequentially outputted with the second pixel selection data at the beginning.

In this manner, the rotation patterns rotate once from the first frame to the eighth frame, and the rotation is repeated similarly in the following frames. In other words, a rotation is performed with one cycle being eight frames.

For example, in a double speed drive for driving at 120 Hz, which is double the image data frame frequency (frame rate) of 60 Hz, the frequency of rotations in the comparison example becomes to be 120 Hz/8=15 Hz. The higher the number of pixels to be multiplex-driven, the lower the rotation frequency becomes.

In this manner, when there is only one rotation pattern, the frequency of averaging operations becomes lower with an increase in the number of pixels to be multiplex-driven. For this reason, the rotation patterns would become more likely to be visually recognized, which causes a problem in that display irregularities would more likely occur.

In this respect, in accordance with the present embodiment, the pattern output circuit 130 outputs one of the rotation patterns PT1—PTM as the output rotation pattern QPT in each frame or a set of plural frames. By this, plural rotation patterns are switched at each frame or a set of plural frames, whereby the frequency of averaging operations can be made higher. In this manner, even when the number of pixels to be multiplex-driven increases, display irregularities can be prevented.

For example, in accordance with the present embodiment, when the frame frequency is greater than 60 Hz, M may set as M=3 or M=5.

By so doing, three or five rotation patterns are switched, such that the frequency of averaging operations can be made higher. For example, when three rotation patterns are to be switched in a double speed drive, the frequency of averaging operations is 120 Hz/3=40 Hz. Alternatively, when five rotation patterns are to be switched in a triple speed drive, the frequency of averaging operations is 180 Hz/5=36 H. These frequencies are higher than the frequency of 15 Hz of the comparison example described above, such that the rotation patterns would become more difficult to be visually recognized. In this manner, display irregularities can be prevented.

Here, in accordance with an aspect of the present embodiment, the pattern output circuit 130 may include pattern registers 310-1−310-M and a pattern selection circuit 300. Further, the pattern registers 310-1−310-M may store the rotation patterns PT1-PTM, and the pattern selection circuit 300 may select and output one of the rotation patterns PT1-PTM.

In this manner, as the pattern output circuit 130 includes the pattern registers 310-1−310-M, the rotation patterns PT1 PTM can be stored therein. Furthermore, as the pattern output circuit 130 includes the pattern selection circuit 300, one of the rotation patterns PT1—PTM can be outputted as the output rotation pattern QPT at each frame or each set of plural frames.

Moreover, in accordance with an aspect of the present embodiment, the order setting circuit 140 may perform a process to convert the output rotation pattern QPT to a different rotation pattern at each horizontal scanning period or each set of plural horizontal scanning periods, thereby setting the driving order for driving the pixels P1i—Ppi. For example, as described with reference to FIG. 9 and other figures, it is also possible to perform the conversion process for rotating the output rotation pattern QPT in p horizontal scanning periods.

By so doing, the output rotation pattern QPT is processed to convert to a different rotation pattern at each horizontal scanning period or each set of plural horizontal scanning periods, whereby order offsets can be averaged within a frame.

Furthermore, in accordance with an aspect of the present embodiment, the order setting circuit 140 may perform the process to convert the output rotation pattern QPT to a different rotation pattern at each frame or each set of plural frames, thereby setting the driving order for driving pixels P1i—Ppi. For example, as described with reference to FIGS. 10A and 10B and other figures, the process to convert the output rotation pattern QPT=PT1 to a different rotation pattern at each three frames may be performed.

By so doing, the output rotation pattern QPT is processed to convert to a different rotation pattern at each vertical scanning period or each set of plural vertical scanning periods, whereby order offsets can be averaged in a plurality of frames.

As described with reference to FIGS. 10A and 10B, in accordance with the present embodiment, the order setting circuit 140 may include the conversion signal generation circuit 330 and the rotation conversion circuit 380. The conversion signal generation circuit 330 may output a conversion signal QC that changes in each horizontal scanning period or each set of plural horizontal scanning periods and in one frame or each set of plural frames. Further, the rotation conversion circuit 380 may perform the process to convert the output rotation pattern QPT to a different rotation pattern based on the conversion signal QC.

This makes it possible to realize the process to convert the output rotation pattern QPT to a different rotation pattern in each horizontal scanning period or each set of plural horizontal scanning periods. Also, it is possible to realize the process to convert the output rotation pattern QPT to a different rotation pattern in each vertical scanning period or each set of plural vertical scanning periods.

In accordance with an aspect of the present embodiment, the conversion signal generation circuit 330 may include the vertical synchronization counter 340, the horizontal synchronization counter 350, the selection timing generation circuit 360 and the addition circuit 370. Further, the addition circuit 370 may process addition of the output value VC of the vertical synchronization counter 340, the output value HC of the horizontal synchronization counter 350 and the output value SC of the selection timing generation circuit 360.

By so doing, the output value VC of the vertical synchronization counter 340 changes at each frame or each set of plural frames, and the output value HC of the horizontal synchronization counter 350 changes at each horizontal scanning period or each set of plural horizontal scanning periods. Further, the addition circuit 370 can process addition of the output value VC, the output value HC and the output value SC, whereby a conversion signal QC that changes at each horizontal scanning period or each set of plural horizontal scanning periods, and changes at each frame or each set of plural frames can be outputted.

Also, in accordance with an aspect of the present embodiment, the selection timing generation circuit 360 may generate count values that rotate at each predetermined count value as pixel selection timing signals, and may output the pixel selection timing signals as the output values SC.

In this manner, the selection timing generation circuit 360 can generate pixel selection timing signals. By this, the order setting circuit 140 can sequentially output pixel selection signals JS according to the pixel selection timing signals. For example, as described with reference to FIG. 9, as the output values SC=0, 1, 2, . . . are sequentially outputted as the pixel selection timing signals, pixel selection signals JS=1, 5, 3, . . . can be sequentially outputted.

Here, in accordance with an aspect of the present embodiment, each of the rotation patterns PT1-PTM may be composed of the first—p-th pixel selection data. Furthermore, the conversion signal generation circuit 330 may output a pixel selection data instruction signal as the conversion signal QC, and the rotation conversion circuit 380 may output, as the pixel selection signal JS, pixel selection data that is indicated by the pixel selection data instruction signal from among the first—p-th pixel selection data of the output rotation pattern QPT. For example, as described with reference to FIG. 9, based on the pixel selection data instruction signal QC=0 that indicates the first pixel selection data, the first pixel selection data 1 of the output rotation pattern QPT may be outputted as the pixel selection signal JS=1.

In this manner, based on the conversion signal QC, relevant pixel selection data among the first—p-th pixel selection data of the output rotation pattern QPT can be outputted as the pixel selection signal JS. This makes it possible to realize the process to convert the output rotation pattern QPT to a different rotation pattern.

### 3. Order Offset Correction

3.1. Exemplary Composition An integrated circuit device of a second exemplary composition in accordance with the present embodiment includes first—n-th (n is a natural number of 2 or greater) data line driving circuits 100-1−100-n (a plurality of data line driving circuits), first—n-th order offset addition circuits 260-1−260-n (a plurality of order offset addition circuits), first—n-th output selection circuits 110-1−110-n (a plurality of output selection circuits), an order offset register 270, a selection circuit 280 and an order setting circuit 140.

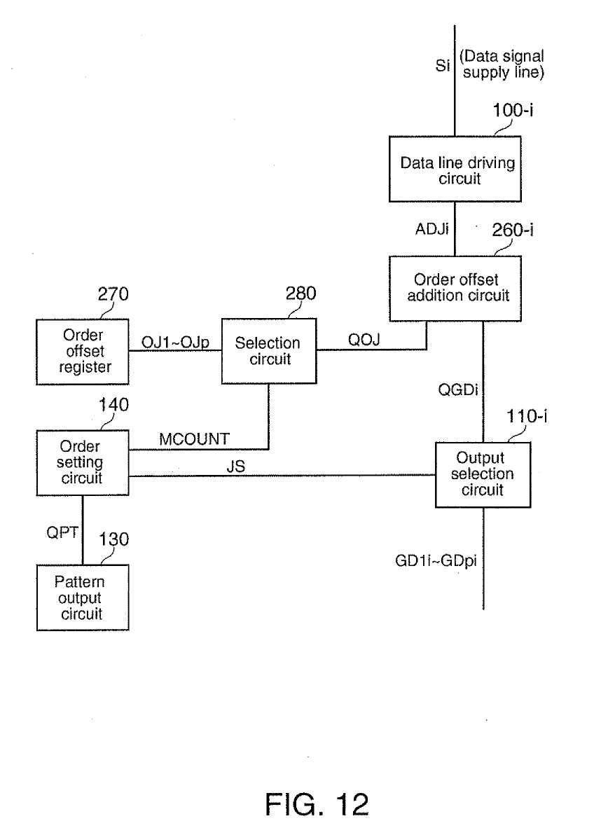

FIG. 12 shows the i-th data line driving circuit 100-i (i is a natural number less than n), the i-th order offset addition circuit 260-i, and the i-th output selection circuit 110-i among the data line driving circuits 100-1−100-n, the order offset addition circuits 260-1−260-n, and the output selection circuits 110-1−110-n of the second exemplary composition. Description will be made with these illustrated components as an example. It is noted that components that have been described with reference to FIG. 7 and other figures, such as the data line driving circuits, will be appended with the same reference numerals, and their description may be omitted if appropriate.

The second exemplary composition pertains to a circuit in which the data line driving circuit performs multiplex driving in which data voltages (or data currents, or data signals in a broader sense) are written to first—p-th pixels P1i-Ppi (a plurality of pixels) in each one horizontal scanning period, and order offset correction values are added to image data, thereby correcting the order offsets in the data voltages.

More concretely, the order setting circuit 140, upon receiving an output rotation pattern QPT from the pattern output circuit 130, outputs an order instruction signal MCOUNT and a pixel selection signal JS. The order instruction signal MCOUNT is a signal that indicates as to which one of the places in the driving order among the first—p-th places in the driving order. For example, the order setting circuit 140 outputs the output value SC of the selection timing generation circuit 360 described with reference to FIG. 8 as the order instruction signal MCOUNT.

The output selection circuit 110-i, upon receiving a pixel selection signal JS instructing to select the q-th pixel Pqi (q is a natural number less than p) in the r-th (r is a natural number less than p) place in the driving order, selects the image data GDqi, and outputs the image data GDqi as the selected image data QGDi.

The order offset register 270 stores order offset setting values OJ1-OJp. For example, as the order offset setting values OJ1-OJp, the order offset register 270 stores first—p-th order offset constant values OJL1-OJLp and first—p-th order offset coefficient values OJM1-OJMp, to be described below. In the order offset register 270, the order offset setting values OJ1-OJp are set by, for example, an unshown host controller (CPU).

Upon receiving the order instruction signal MCOUNT and the order offset setting values OJ1-OJp, the selection circuit 280 outputs a selected offset setting value QOJ. More concretely, the selection circuit 280, upon receiving the order instruction signal MCOUNT indicating the r-th place in the driving order, selects the order offset setting value OJr, and outputs the order offset setting value OJr as the selected offset setting value QOJ.

The order offset addition circuit 260-i, upon receiving the selected offset setting value QOJ and the selected image data QGDi, obtains an order offset correction value ΔOJi. Then, the selected image data QGDi and the order offset correction value ΔOJi are added, and the addition-processed image data is outputted as added image data ΔDJi. For example, let us consider an instance where the data line driving circuit 100-i drives the pixel Pqi in the r-th place in the order in one horizontal scanning period. In this instance, for example, an order offset constant value OJLr and an order offset coefficient value OJMr are inputted as the order offset setting value QOJ in the order offset addition circuit 260-i. Then, the order offset addition circuit 260-i obtains an order offset correction value ΔOJi=OJLr+OJMr×GDqi, and then outputs added image data ADGi=GDqi+ΔOJi.

Here, the process of adding the selected image data QGDi and the order offset correction value ΔOJi is not limited to simple addition of the selected image data QGDi and the order offset correction value ΔOJi, but may further include processing of addition with other data, or processing of multiplication with other data.

It is noted that the integrated circuit device in accordance with the embodiment of the invention is not limited to the composition of FIG. 12, but it is possible to make many modifications including omission of a portion of the components thereof (for example, the selection circuit 280 and the like), addition of other components thereto, and the like.

### 3.2. Operation of Order Offset Correction

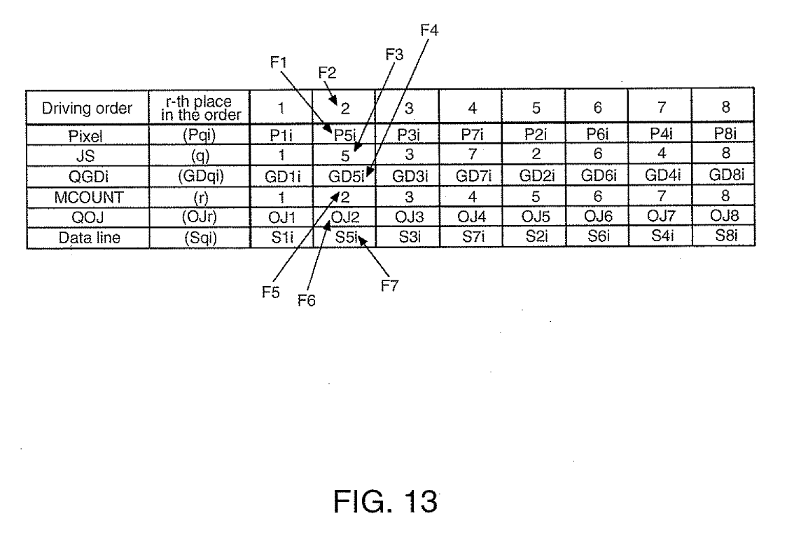

Referring to FIG. 13, an example of operations of the second exemplary composition will be described concretely. Referring to FIG. 13, description is made as to an example in which the data line driving circuit 100-i writes data voltages to pixels P1i-P8i (p=8) in one horizontal scanning period.

In this case, as the order of driving the pixels P1i-P8i, the first—eighth places in the driving order in one horizontal scanning period are set. For example, the second place (the r-th place) in the driving order indicated by F2 is set as the driving order for the pixel P5i (pixel Pqi, q=5) indicated by F1 in FIG. 13.

In this instance, as indicated by F3, a pixel selection signal JS instructing to select the pixel P5i is outputted. Based on the pixel selection signal JS, image data GD5i (GDqi) is selected, as indicated by F4, and selected image data QGDi=GD5i is outputted.

Also, as indicated by F5, an order instruction signal MCOUNT instructing the second place (the r-th place) in the driving order is outputted. Then, as indicated by F6, an order offset setting value OJ2 (OJr) is selected based on the order instruction signal MCOUNT, and a selected offset setting value QOJ=OJ2 is outputted.

Then, based on the selected offset setting value OJ2 and the selected image data GD5i, added image data ADGi is outputted. Based on the added image data ADGi, the data line S5i (Sqi) is driven, as indicated by F7.

In multiplex driving, there is a problem in that order offsets that differ depending on the order of driving the pixels P1i-Ppi are generated in data voltages to be written to the pixels P1i-Ppi (for example, ΔVJA1-ΔVJA3, ΔVJC1-ΔVJC3 in FIG. 6). The order offsets cause a problem of generation of display irregularities.

In this respect, in accordance with the present embodiment, the order offset register 270 stores the order offset setting values OJ1-OJp correlated to the first—the p-th places in the driving order, and the order setting circuit 140 sets an order of driving the pixels P1i-Ppi. Then, when the data line driving circuit 100-i drives the pixel Pqi in the r-th place in the order according to the driving order, the order offset addition circuit 260-i obtains an order offset correction value ΔOJi corresponding to the r-th place in the driving order based on the order offset setting value OJr, and processes addition of the order offset correction value ΔOJi to the image data GDqi, and outputs the addition-processed image data ADGi to the data line driving circuit 100-i.

In accordance with the present embodiment, the order offset register 270 stores the order offset setting values OJ1-OJp correlated to the first—the p-th places in the driving order, and the order setting circuit 140 sets an order of driving the pixels P1i-Ppi. By this, the order of driving the pixels P1i-Ppi is set, and the order offset correction value ΔOJi corresponding to the r-th place in the driving order can be obtained based on the order offset setting value OJr.

Furthermore, in accordance with the present embodiment, when the data line driving circuit 100-i drives the pixel Pqi in the r-th place in the driving order, the order offset addition circuit 260-i processes addition of the order offset correction value ΔOJi corresponding to the r-th place in the driving order to the image data GDqi. By this, order offsets in data voltages to be written to the pixels P1i-Ppi can be corrected. Therefore, generation of display irregularities due to the order offsets can be prevented.

In this manner, in accordance with the present embodiment, by correcting image data to thereby suppress order offsets, the operation of averaging order offsets through rotating the driving order for driving pixels can be made more effective,

Here, in accordance with the present embodiment, the order offset register 270 stores order offset constant values OJL1-OJLp, as the order offset setting values OJ1-OJp, and the order offset addition circuit 260-i may process addition of the order offset constant value OJLr, as the order offset correction value ΔOJi, to the image data GDqi.

In this manner, by adding the order offset constant value OJLr to the image data GDqi, order offsets that are constant in characteristic with respect to the grayscale of the image data can be corrected.

Furthermore, in accordance with the present embodiment, the order offset register 270 may store order offset coefficient values OJM1-OJMp, as the order offset setting values OJ1-OJp, and the order offset addition circuit 260-i may process addition of a value obtained as the order offset correction value ΔOJi by multiplying an order offset coefficient value OJMr and the image data GDqi to the image data GDqi.

In this manner, by processing addition of a value which is obtained by multiplying the order offset coefficient value OJMr and the image data GDqi to the image data GDqi, order offsets having an inclination in characteristic with respect to the grayscale of the image data can be corrected.

### 4. Data Driver

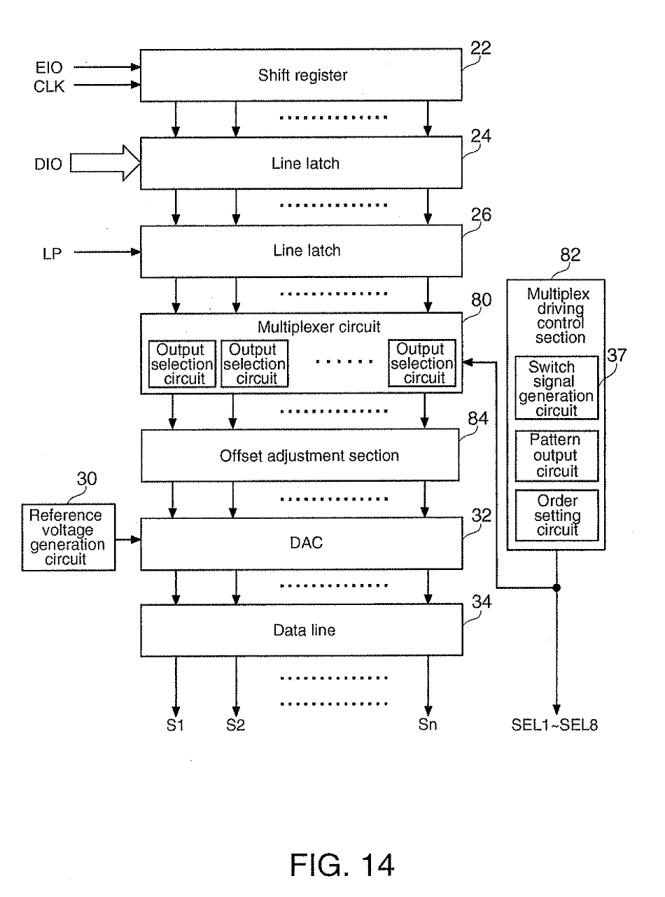

FIG. 14 shows a modified example of a data driver. The data driver shown in FIG. 14 is applicable, for example, to the data driver 20 described above with reference to FIG. 1.

The modified example shown in FIG. 14 includes a shift register 22, line latches 24, 26, a multiplexer circuit 80, an offset adjustment section 84, a reference voltage generation circuit 30, a DAC 32, a data line driving circuit 34, and a multiplex drive control section 82. It is noted that components to be described below that are the same as those described with reference to FIG. 2 or the like, such as, the data line driving circuits and the like, are appended with the same reference numbers, and their description may be omitted if appropriate.

The multiplex drive control section 82 may include a pattern output circuit described above with reference to FIG. 7, etc. The multiplex drive control section 82 generates multiplex control signals SEL1-SEL8 (SEL1-SELp), based on a driving order set by the pattern output circuit and the order setting circuit.

The multiplexer circuit 80 may include output selection circuits described with reference to FIG. 7, etc., corresponding to the data signal supply lines, respectively. The output selection circuits select and output image data, based on the multiplex control signals SEL1-SEL8 given from the multiplex drive control section 82.

The offset adjustment section 84 processes correction of order offsets. The offset adjustment section 84 may include an order offset register and an order offset addition circuit, described above with reference to FIG. 12, etc.

### 5. Electronic Apparatus

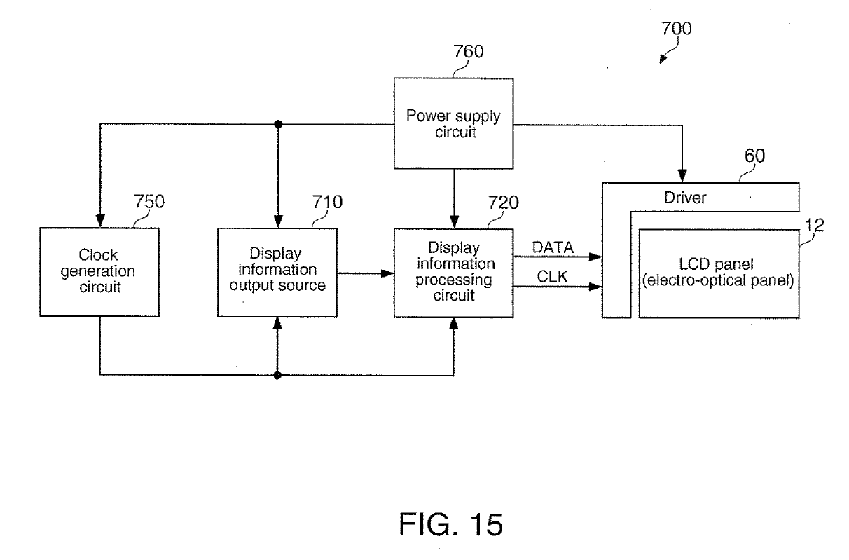

FIG. 15 shows an exemplary composition of a projector (an electronic apparatus) to which the integrated circuit device in accordance with the present embodiment is applied.

The projector 700 (a projection type display device) includes a display information output source 710, a display information processing circuit 720, a driver 60 (a display driver), a liquid crystal panel 12 (an electro-optical panel in a broader sense), a clock generation circuit 750 and a power supply circuit 760.

The display information output source 710 includes a memory device, such as, a read only memory (ROM), a random access memory (RAM), an optical disc device or the like, and a tuning circuit for tuning and outputting image signals. The display information output source 710 outputs display information such as image signals in a predetermined format and the like to the display information processing circuit 720 based on a clock signal given from the clock generation circuit 750.

The display information processing circuit 720 may include an amplification-polarity inversion circuit, a phase expansion circuit, a rotation circuit, a gamma correction circuit, a clamping circuit, and the like.

The driver 60 includes a scanning driver (a gate driver) and a data driver (a source driver), and drives the liquid crystal panel 12 (an electro-optical panel). The power supply circuit 760 supplies power to each of the circuits described above.

It is noted that, although some embodiments of the invention have been described in detail above, those skilled in the art would readily appreciate that many modifications are possible in the embodiments without departing in substance from the novel matter and effects of the invention. Accordingly, such modifications are deemed to be included within the scope of the invention. For example, throughout the specification and the drawings, any terms (liquid crystal display device, liquid crystal panel, driver, source voltage, source line, gate line and the like) described at least once with other different terms (electro optical device, electro optical panel, integrated circuit device, data voltage, data line, scanning line and the like) that encompass broader meaning or are synonymous can be replaced with these different terms in any sections of the specification and the drawings. Also, the structures and operations of the integrated circuit devices, the electro optical devices, the electronic apparatuses and the like are not limited to those described in the present embodiments, and many modifications can be made.

What is claimed is:

1. An integrated circuit device comprising:
a data line driving circuit that is provided for each of a plurality of data signal supply lines and supplies a multiplexed data signal to a corresponding data signal supply line among the plurality of data signal supply lines;
a pattern output circuit; and
an order setting circuit,
wherein a plurality of data signals after demultiplexing obtained by demultiplexing the multiplexed data signal by a demultiplexer are supplied to a plurality of pixels in one horizontal scanning period,
the pattern output circuit outputs, as an output rotation pattern, at each frame or each set of plural frames, one of first rotation pattern—M-th (M is a natural number of 2 or more) rotation pattern, which are rotation patterns each defining an order of driving first pixel—p-th (p is a natural number of 2 or more) pixel among the plurality of pixels, and
the order setting circuit sets an order of driving the first pixel—the p-th pixel based on the output rotation pattern.

2. An integrated circuit device according to claim 1, comprising a switch signal generation circuit that generates a demultiplexing switch signal for controlling on and off of a plurality of demultiplexing switch elements included in the demultiplexer.

3. An integrated circuit device according to claim 1, comprising an output selection circuit that is provided corresponding to the data line driving circuit and selects and outputs, based on a pixel selection signal from the order setting circuit, one of first image data—p-th image data corresponding to the first pixel—the p-th pixel.

4. An integrated circuit device according to claim 1, wherein the pattern output circuit includes a first pattern register—a M-th pattern register that store the first rotation pattern—the M-th rotation pattern, and
a pattern selection circuit that selects and outputs one of the first rotation pattern—the M-th rotation pattern stored in the first pattern register—the M-th pattern register at each frame or each set of plural frames.

5. An integrated circuit device according to claim 1, wherein, in a double speed drive in which the frame frequency is 120 Hz, M is set to 3, and the first rotation pattern—the M-th rotation pattern are rotated at 40 Hz and outputted as the output rotation pattern.

6. An integrated circuit device according to claim 1, wherein, in a triple speed drive in which the frame frequency is 180 Hz, M is set to 5, and the first rotation pattern—the M-th rotation pattern are rotated at 36 Hz and outputted as the output rotation patterns.

7. An integrated circuit device according to claim 1, wherein the order setting circuit performs a process to convert the output rotation pattern to a different rotation pattern in each horizontal scanning period or each set of plural horizontal scanning periods, thereby setting the order of driving the first pixel—the p-th pixel.

8. An integrated circuit device according to claim 7, wherein the order setting circuit performs a process to convert the output rotation pattern to a different rotation pattern in each frame or each set of plural frames, thereby setting the order of driving the first pixel—the p-th pixel.

9. An integrated circuit device according to claim 8, wherein the order setting circuit includes a conversion signal generation circuit that outputs a conversion signal that changes in each horizontal scanning period or each set of plural horizontal scanning periods and in each frame or each set of plural frames, and a rotation conversion circuit that processes to convert the output rotation pattern to a different rotation pattern based on the conversion signal.

10. An integrated circuit device according to claim 9, wherein the conversion signal generation circuit includes a vertical synchronization counter that counts the number of frames, a horizontal synchronization counter that counts the number of horizontal scanning periods, a selection timing generation circuit that generates a pixel selection timing signal in the demultiplexing, and an addition circuit that processes addition of an output value of the vertical synchronization counter, an output value of the horizontal synchronization counter and an output value of the selection timing generation circuit.

11. An integrated circuit device according to claim 10, wherein the selection timing generation circuit generates count values that rotate at each predetermined count value as the pixel selection timing signals.

12. An integrated circuit device according to claim 9, wherein
each rotation pattern in the first rotation pattern—the M-th rotation pattern is composed of first pixel selection data—p-th pixel selection data,
the conversion signal generation circuit outputs a pixel selection data instruction signal as the conversion signal, and
the rotation conversion circuit outputs pixel selection data selected from the first pixel selection data—the p-th pixel selection data of the output rotation pattern, which is instructed by the pixel selection data instruction signal, as a pixel selection signal, thereby setting the order of driving the first pixel—the p-th pixel.

13. An integrated circuit device according to claim 1, comprising
an order offset register that stores a first order offset setting value—a p-th order offset setting value corresponding to order offsets that are offsets generated in the plurality of data signals after the demultiplexing depending on the order of driving the first pixel—the p-th pixel, and
an order offset addition circuit corresponding to the data line driving circuit,
wherein, when each of the data line driving circuits drives, among the first pixel—the p-th pixel, the q-th (q is a natural number less than p) pixel in the r-th (r is a natural number less than p) place in the order,
the order offset addition circuit processes addition of an order offset correction value based on the r-th order offset setting value among the first order offset setting value—the p-th order offset setting value to the q-th image data among the first image data—the p-th image data corresponding to the first pixel—the p-th pixel.

14. An electro optical device comprising the integrated circuit device recited in claim 1.

15. An electronic apparatus comprising the electro optical device recited in claim 14.
